(19) United States
(12) Patent Application Publication
(10) Pub. No.: US 2010/0133439 A1
(43) Pub. Date: Jun. 3, 2010

(54) Detector Device for Monitoring Scrap Metal for Radioactive Components

(75) Inventors: Michael Iwatschenko-Borho, Erlangen (DE); Norbert Trost, Erlangen (DE)

Correspondence Address: LERNER GREENBERG STEMER LLP, P O BOX 2480, HOLLYWOOD, FL, 33022-2480, US

(73) Assignee: THERMO FISHER SCIENTIFIC MESSTECHNIK GMBH, Erlangen (DE)

(21) Appl. No.: 12/625,737

(22) Filed: Nov. 25, 2009

Related U.S. Application Data
(60) Provisional application No. 61/119,524, filed on Dec. 3, 2008.

(30) Foreign Application Priority Data
Nov. 26, 2008 (DE) DE102008044086.8

(51) Int. Cl. G01T 1/20

(52) U.S. Cl. 250/361 R

(57) ABSTRACT

A detector device for monitoring metal scrap for radioactive components includes a gamma detector for detecting gamma radiation. The gamma detector is disposed in a protective housing which can be mounted in such a way that it projects into a pick-up area of a load suspension device which picks up the metal scrap. The gamma detector contains a scintillator as a gamma-sensitive element with a sensitive volume of less than 20 cm³.

### CROSS-REFERENCE TO RELATED APPLICATION

This application claims the priority, under 35 U.S.C. §119(e), of Provisional Application No. U.S. 61/119,524, filed Dec. 3, 2008, this application also claims the priority, under 35 U.S.C. §119, of German Patent Application DE 10 2008 044 086.8, filed Nov. 26, 2008; the prior applications are herewith incorporated by reference in their entirety.

### BACKGROUND OF THE INVENTION

### Field of the Invention

The invention relates to a detector device for monitoring metal scrap or waste for radioactive components, as the device is used in load suspension devices, in particular in hydraulic or multi-claw grabs.

Metal scrap or waste is an important raw material for producing steel and nonferrous metals and is predominantly derived from so-called capital scrap or old metals, i.e. collected metal products which no longer have any use, such as those that accrue when dismantling industrial plants, for example. The capital scrap or old metal can be considerably radioactively contaminated since either the plant parts themselves can be radioactively contaminated or radiation-activated, for example plant parts from civilian or military nuclear power plants, or they can contain encapsulated radioactive sources which were used in the dismantled plants, for example medical devices, the existence of which has been forgotten. Before the metal scrap is melted and further processed, it therefore needs to be monitored for the presence of radioactive components. Such radioactive components are typically gamma sources, in particular Co-60, Cs-137, Ir-192 and Am-241. Monitoring for such radioactive components is effected both by using stationary measurement systems, for example so-called portal monitors through which transport vehicles that are loaded with metal scrap drive, and also by using portable measurement instruments or detector devices which are disposed on load suspension devices for loading the metal scrap, such as hydraulic or multi-claw grabs.

A load suspension device 2, which in the example is a hydraulic or multi-claw grab, that is provided with such a detector device for monitoring metal scrap for radioactive components, as is used in the prior art, is shown in FIG. 1. Such a hydraulic grab includes a plurality of shell-shaped gripper arms 4 that are disposed on a base 6, which is a so-called shell mount, in such a way that they can pivot. A detector device 10 for detecting gamma radiation is disposed on the load suspension device 2 on a side which faces a pick-up area 8 that is used for picking up the metal scrap. In the illustrated example, the detector device 10 is on the base 6 of the hydraulic grab. The detector device 10 includes a gamma detector 14, in the figure the gamma detector 14 (indicated by a dashed line) has a scintillator as a gamma-sensitive element, which is disposed in a protective housing 12. A supply unit 16 is also disposed on the load suspension device 2 outside the pick-up area 8. The supply unit 16 supplies voltage to the gamma detector 14 and transmits measurement signals it detects through radio to a non-illustrated operating and display unit.

The protective housing 12 is typically made of steel and has a solid construction in order to protect the detector against damage by the scrap parts picked up by the load suspension device 2. In order to achieve a high detection sensitivity, gamma detectors with scintillators that have as large a volume as possible, are used in the prior art. The use of such high-volume gamma detectors, however, requires correspondingly large protective housings 12 which accordingly have to have great wall thickness, usually on the order of magnitude of 20 mm, at least in the regions which face the pick-up area 8 and come into contact with metal scrap in order to achieve the necessary stability.

Such a detector device 10 known in the prior art is shown diagrammatically in FIG. 2. The gamma detector 14, with a large sensitive volume V, is located in the solid protective housing 12. In order to penetrate into the sensitive volume V of the gamma detector 14, gamma rays γ, which strike the protective housing 12 from various directions α, must first penetrate the wall of the protecting housing 12. A path distance s traveled inside the wall increases with increasing angles of incidence α. The gamma rays γ to be detected are very frequently low-energy gamma quanta having energies of typically less than 200 keV. The reason for this is that even if the radiation sources in the metal scrap are Cs-137, for example, which mainly emits gamma quanta with an energy of 662 keV, the gamma quanta are shifted into the low-energy range due to multiple Compton scattering either already inside the screening housing which surrounds an encapsulated gamma source or inside the metal scrap which surrounds the gamma source. A large part of such low-energy gamma rays, however, is already absorbed in the wall of the protective housing. The gamma quanta emitted by Am-241 with an energy of about 60 keV are practically undetectable using a detector device having a gamma detector which is disposed in a protective steel housing with a wall thickness of 20 mm, since the half-value layer for steel in the case of this photon energy is merely about 1 mm. Accordingly, a path distance traveled in steel of 20 mm results in an intensity drop to about one millionth of the initial value.

In order to still be able to detect such low-energy gamma radiation, a cover plate 18 which faces the pick-up area of the load suspension device is often provided with a plurality of openings 20 in the prior art. The diameter of those openings 20 and the number thereof are limited in order to ensure a continued sufficient stability of the protective housing 12. In addition, if the openings 20 are too large, scrap parts can get inside the protective housing 12 and result in destruction of the gamma detector 14. FIG. 2 thus shows that only such low-energy gamma rays γ which strike the cover plate 18 of the protective housing 12 at right angles can enter the protective housing 12. A conical shape of the openings 20 with an outwardly increasing diameter would in principle also enable gamma rays γ with other angles of incidence α to pass through the opening, but due to its funnel effect, such a shape carries with it a great risk that scrap fragments might become wedged in the openings 20.

In the nomogram of FIG. 3, a ratio)I(α)/I(α=0° of an intensity I(α) of the gamma radiation transmitted through a steel plate at an angle of incidence α and of an intensity I(α=0° of the gamma radiation transmitted through a steel plate at an angle of incidence α=0° with an energy of 100 keV, is plotted with respect to the angle of incidence α. Curves a, b, c and d represent the ratios for a steel plate having a respective thickness of 2 mm, 5 mm, 10 mm and 20 mm. The nomogram shows that, in the case of the steel plate with a thickness of 20 mm and at an angle of incidence α=45°, the proportion of gamma quanta which penetrate the steel plate is now only about 15% of the proportion of the gamma quanta which pass through the steel plate at an angle of incidence α=0°, that is to say about 0.4% of the gamma quanta which strike the protective housing. This effect is all the more pronounced if the gamma radiation energy is even lower.

### SUMMARY OF THE INVENTION

It is accordingly an object of the invention to provide a detector device for monitoring metal scrap for radioactive components, which overcomes the hereinafore-mentioned disadvantages of the heretofore-known devices of this general type, which is suitable for use in a load suspension device and which has increased detection sensitivity in comparison to known detector devices.

With the foregoing and other objects in view there is provided, in accordance with the invention, in a load suspension device having a pick-up area for picking up metal scrap, a detector device for monitoring the metal scrap for radioactive components. The detector device comprises a protective housing to be mounted for projecting into the pick-up area. A gamma detector is disposed in the protective housing for detecting gamma radiation. The gamma detector contains a scintillator as a gamma-sensitive element with a sensitive volume of less than 20 cm³.

Since the sensitive volume of the gamma detector which is used is this small, the detector can be encapsulated in a relatively small protective housing that exhibits sufficient mechanical stability against the forces which occur inside the load suspension device when picking up metal scrap due to its small dimensions with significantly lower wall thickness than is the case in protective housings used in the prior art. Due to the reduced wall thickness which made is possible in this way, the detection sensitivity is significantly improved with respect to the detector device known in the prior art, despite the smaller sensitive volume.

Accordingly, the invention proceeds from the assumption that the use of gamma detectors, which is customary in the prior art, having a large gamma-sensitive volume is counterproductive for two reasons.

Firstly, an increase in the size of this volume is inevitably accompanied by an increase, which is nearly proportional to the volume, of the zero effect (background radiation) measured in the absence of artificial radioactive radiation, because the zero effect is substantially based on high-energy radiation of the natural radioactivity present in the surroundings, for example in the ground or in building materials, which also penetrates solid protective housings. However, low-energy gamma radiation of artificial, possibly encapsulated radiation sources is largely detected within the first few millimeters of the inorganic scintillator (e.g. NaI(TI) crystal) which is generally used as the gamma-sensitive element and is thus proportional to the surface area rather than the volume.

Secondly, the great wall thickness required for a large volume significantly reduces the intensity of the artificial gamma radiation penetrating the protective housing. Both effects add up and in the case of an increase in the size of the gamma detector result in a significant worsening of the signal-to-noise ratio and thus in a considerable worsening of the detection sensitivity.

The detection sensitivity, which is improved in a detector device according to the invention, is also advantageous in conjunction with regular function testing using a radioactive test radiation source since, due to the improved detection sensitivity, its activity can be selected to be substantially lower than in the case of spatially expanded scintillators used in the prior art. This is especially important since the operating staff is usually made up of persons who are not subject to radiation monitoring and strict exemption thresholds for the test radiation sources must be observed as a result.

In accordance with another feature of the invention, since, due to the lower wall thickness, even low-energy gamma quanta penetrate into the interior of the protective housing with a significantly higher probability, the protective housing in one advantageous embodiment of the invention is completely closed at least in its region or part which projects freely into the pick-up area, i.e. it has no openings, as are necessary in the protective housings known in the prior art for detecting low-energy gamma quanta. In this manner, the detector is completely encapsulated and foreign parts are prevented from entering the protective housing.

In accordance with a further feature of the invention, if the protective housing in that region or part which projects into the pick-up area has a convex shape, the mechanical stability of the protective housing even in the case of a smaller wall thickness of this part, which is preferably less than 8 mm in the case of a protective housing made of steel, is additionally increased.

In accordance with a concomitant feature of the invention, the sensitivity is furthermore increased in comparison to gamma quanta which are incident from the side, with central positioning of the scintillator within the convex housing resulting in a minimum path length of the incident radiation, which strikes the scintillator, within the wall of the protective housing.

Other features which are considered as characteristic for the invention are set forth in the appended claims.

Although the invention is illustrated and described herein as embodied in a detector device for monitoring metal scrap for radioactive components, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a hydraulic grab with a detector device mounted therein for monitoring metal scrap for radioactive components, according to the prior art;

FIG. 2 is a cross-sectional view of a detector device for monitoring metal scrap for radioactive components, as is used in the prior art;

FIG. 3 is a nomogram in which a transmission of gamma rays with an energy of 100 keV through a steel plate is shown as a function of a thickness of the steel plate and of an angle of incidence; and

FIGS. 4 and 5 are mutually perpendicular cross-sectional views, respectively taken along the lines V-V and IV-IV in the direction of the arrows, each showing a basic illustration of a detector device according to the invention.

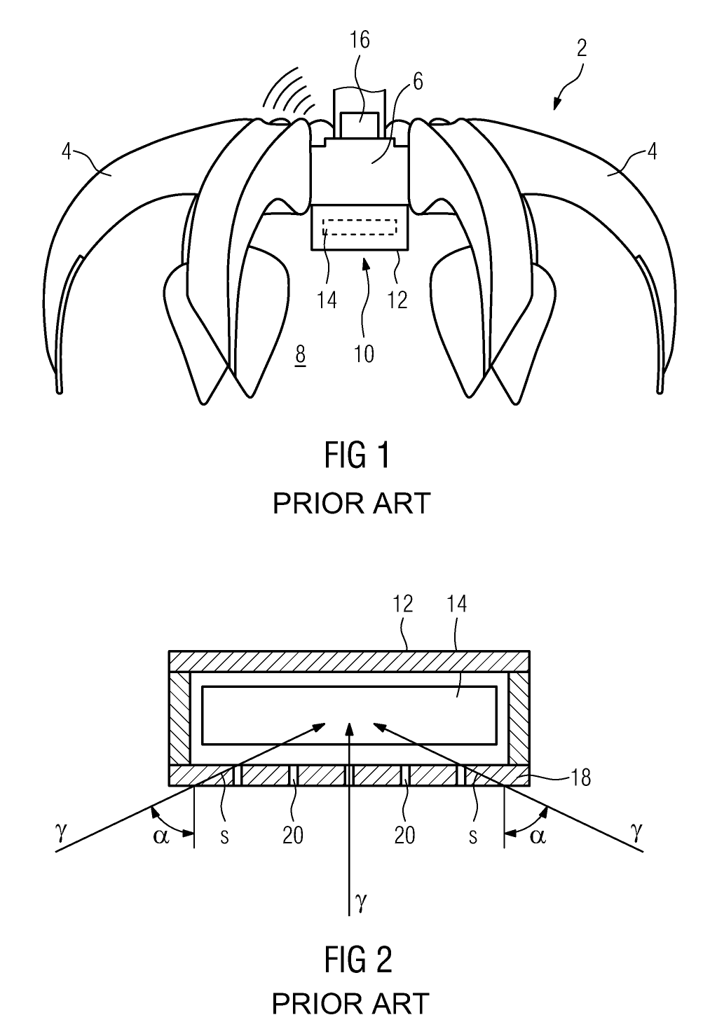

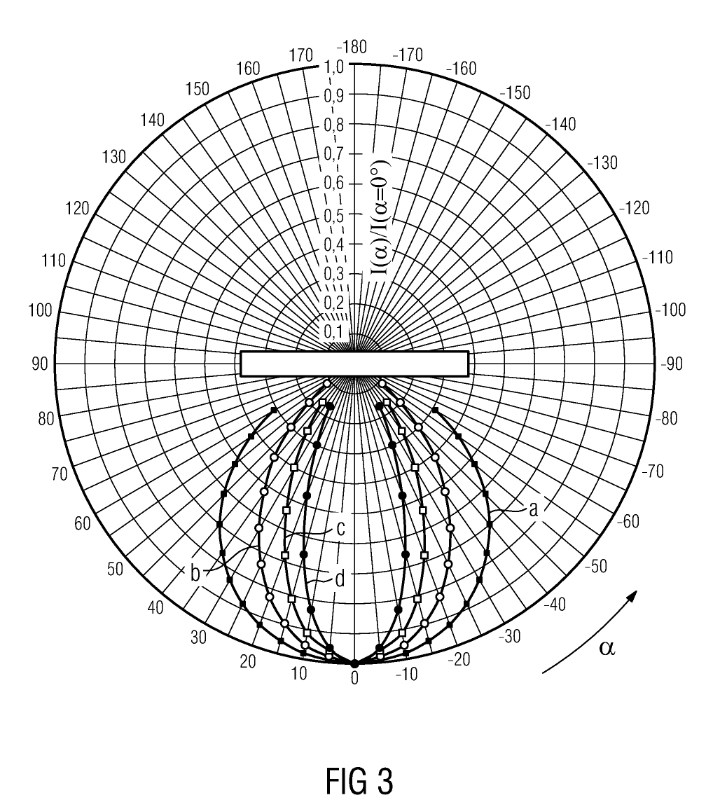

### DETAILED DESCRIPTION OF THE INVENTION

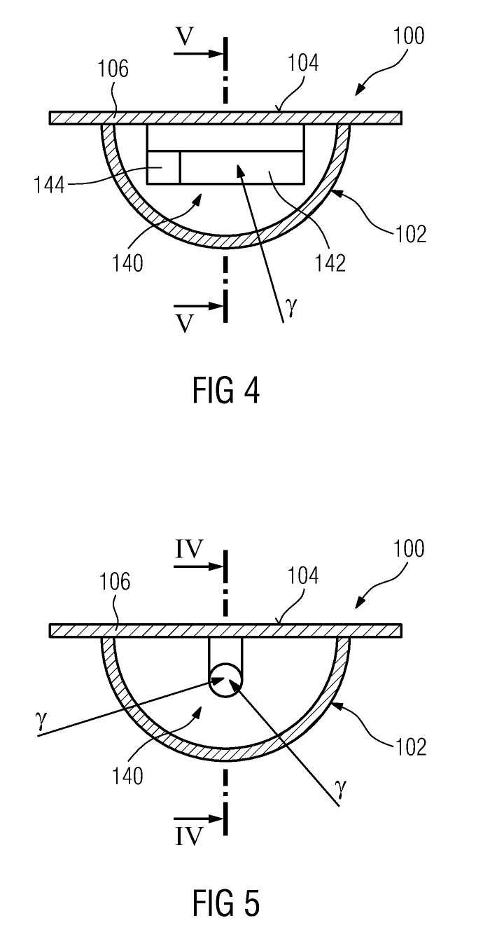

Referring now to the figures of the drawings in detail and first, particularly, to FIGS. 4 and 5 thereof, there is seen a detector device 100 according to the invention which includes a protective housing 102 that has a base 106, which is matched to a load suspension device, on its mounting side 104, by which it can be disposed and secured to a load suspension device in the direct vicinity of its pick-up area or in such a way that it projects into its pick-up area. The protective housing 102 is made of steel which is typically hardened for reasons of mechanical strength. In the example, a planar plate is shown as the base 106 for mounting to the likewise planar underside of the base of a hydraulic or multi-claw grab. The protective housing 102 has a convex, i.e. outwardly curved shape in the form of a dome, for example a spherical cap, on the side which is remote from the mounting side 104. In the mounted state, the convex region of the protective housing 102, which region is completely closed, i.e. has no openings, projects freely into the pick-up area of the load suspension device.

Disposed inside the protective housing 102 is a gamma detector 140 which includes a scintillator 142, preferably an inorganic NaI(TI) or CsI(TI) single crystal, as the gamma-sensitive element. The scintillator 142 is cylindrical and coupled by one of its end faces to a photomultiplier 144. The volume of the scintillator 142, i.e. the actual sensitive volume of the gamma detector 140, is less than 20 cm³, with volumes of between 5 and 10 cm³ having proven especially advantageous in particular for NaI(TI) detectors. In the case of such small scintillator volumes, the wall thickness of that part of the protective housing 102 which serves as the ray entry area and projects freely into the pick-up area can be limited to values of less than 8 mm.

The scintillator 142 is disposed in as central a position as possible inside the convex protective housing 102. Due to the convex shape of the protective housing 102 on that side which is remote from the mounting side 104 and due to the position of the scintillator 142, which is as central as possible, the path distance traveled by the gamma rays γ, which strike the convex surface, in the wall of the protective housing 102, is virtually independent of the direction from which the gamma quanta strike the protective housing 102. Since in the case of such central positioning—in the ideal case, the center of gravity or centroid of the scintillator 142 and the center point of a protective housing 102 which is in the form of a spherical cap coincide—the gamma radiation γ passes through the wall in a nearly radial manner, and the path distance traveled inside the wall is also minimal. Such a convex shape, which is accompanied by the advantage that even gamma radiation γ, which strikes the protective housing 102 from the side and is directed onto the gamma detector 140, can still be detected with a high degree of detection sensitivity, is possible because the total volume of the detector device is correspondingly small, with the result that even a convex protective housing 102 does not protrude more deeply, but instead clearly less deeply into the pick-up area than the known flat protective housings with large-volume gamma detectors.

1. In a load suspension device having a pick-up area for picking up metal scrap, a detector device for monitoring the metal scrap for radioactive components, the detector device comprising:
a protective housing to be mounted for projecting into the pick-up area; and
a gamma detector disposed in said protective housing for detecting gamma radiation, said gamma detector containing a scintillator as a gamma-sensitive element with a sensitive volume of less than 20 cm³.

2. The detector device according to claim 1, wherein said protective housing has a region projecting freely into the pick-up area, and said protective housing is completely closed at least in said region.

3. The detector device according to claim 2, wherein said region of said protective housing projecting freely into the pick-up area has a convex shape.

4. The detector device according to claim 3, wherein said scintillator is disposed in a central position in said protective housing.

5. The detector device according to claim 2, wherein said protective housing is made of steel and has a wall thickness which is less than 8 mm at least in said region projecting freely into the pick-up area.

6. The detector device according to claim 1, wherein said scintillator is an NaI(TI) or CsI(TI) single crystal.
